(19) United States
(12) Patent Application Publication
(10) Pub. No.: US 2026/0331636 A1
(43) Pub. Date: Oct. 22, 2026

(54) BATTERY PACK

(71) Applicant: TOYOTA JIDOSHA KABUSHIKI KAISHA, Toyota-shi (JP)

(72) Inventors: Osamu YAMASHITA, Toyota-shi (JP); Takuya ARAKAWA, Nagakute-shi (JP); Makoto IWATA, Toyota-shi (JP); Kenta KIMURA, Nagoya-shi (JP); Ryo KIMURA, Nagoya-shi (JP); Kunihiro TSUNEKAWA, Toyota-shi (JP); Koichi YANASE, Nagoya-shi (JP)

(73) Assignee: TOYOTA JIDOSHA KABUSHIKI KAISHA, Toyota-shi (JP)

(21) Appl. No.: 19/468,037

(22) Filed: Feb. 3, 2026

(30) Foreign Application Priority Data
Apr. 8, 2025 (JP) 2025-063820

(51) Int. Cl. H01M 10/6556; H01M 10/613; H01M 10/625; H01M 50/24; H01M 50/242; H01M 50/249; H01M 50/262

(52) U.S. Cl. CPC H01M 10/6556; H01M 10/613; H01M 10/625; H01M 50/24; H01M 50/242; H01M 50/249; H01M 50/262

(57) ABSTRACT

A battery pack may include a battery cell, a cooler located below the battery cell and having a cooling channel, and a protection panel that covers the cooler from a bottom. A groove extending along the cooling channel may be provided to a lower surface of the cooler. At least one reinforcing rib protruding toward the cooler may be provided to an upper surface of the protection panel. The reinforcing rib may be accommodated in the groove of the cooler.

### CROSS-REFERENCE TO RELATED APPLICATION

This application claims priority to Japanese Patent Application No. 2025-063820 filed on Apr. 8, 2025. The disclosure of the above-identified application, including the specification, drawings, and claims, is incorporated by reference herein in its entirety.

### BACKGROUND

### 1. Technical Field

The technology disclosed in the present specification relates to battery packs.

### 2. Description of Related Art

Japanese Unexamined Patent Application Publication No. 2023-046671 (JP 2023-046671 A) describes a battery pack mounted on an electrified vehicle. This battery pack includes battery cells, a cooler disposed below the battery cells, and a protection panel that covers the cooler from the bottom.

### SUMMARY

Typically, the battery pack is disposed under the floor of the electrified vehicle. In this case, the protection panel is exposed below the electrified vehicle. To increase the rigidity of the protection panel, it is conceivable to provide reinforcing ribs to the protection panel. When the reinforcing ribs are provided to the protection panel, however, the substantial thickness of the protection panel increases. As a result, the dimension of the battery pack in an up-down direction increases as well. The present specification provides a technology for increasing the rigidity of a protection panel while suppressing an increase in dimension of a battery pack.

The technology disclosed in the present specification is embodied in a battery pack. The battery pack may include a battery cell, a cooler located below the battery cell and having a cooling channel, and a protection panel that covers the cooler from a bottom. A groove extending along the cooling channel may be provided to a lower surface of the cooler. At least one reinforcing rib protruding toward the cooler may be provided to an upper surface of the protection panel. The reinforcing rib may be accommodated in the groove of the cooler.

In the above configuration, the reinforcing rib provided to the protection panel is accommodated in the groove of the cooler. Therefore, even when the substantial thickness of the protection panel increases by providing the reinforcing rib to the protection panel, an increase in dimension of the battery pack in the up-down direction can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows the configuration of an electrified vehicle;

FIG. 2 shows the configuration of a battery pack;

FIG. 3 shows the configuration of a battery module;

FIG. 4 is a sectional view taken along line IV-IV in FIG. 2;

FIG. 5 shows the configuration of a bottom wall of a casing; and

FIG. 6 shows the configuration of a protection panel.

### DETAILED DESCRIPTION OF EMBODIMENTS

In one embodiment of the present technology, at least one joining rib protruding toward the cooler may be provided to the protection panel, and the protection panel may be joined to the cooler at the joining rib via an adhesive. In this case, the reinforcing rib may extend in a first direction on the upper surface of the protection panel, and the joining rib may extend in a second direction intersecting the first direction on the upper surface of the protection panel. With this configuration, the rigidity of the protection panel is effectively increased by the combination of the reinforcing rib and the joining rib extending in different directions.

In the above embodiment, on the upper surface of the protection panel, a width dimension of the reinforcing rib that is perpendicular to the first direction may be smaller than a width dimension of the joining rib that is perpendicular to the second direction. By setting the relatively large width dimension of the joining rib, the protection panel can be firmly bonded to the cooler. By setting the relatively small width dimension of the reinforcing rib, the reinforcing rib can be easily accommodated in the groove of the cooler.

Instead of or in addition to the above configuration, on the upper surface of the protection panel, a protruding height dimension of the reinforcing rib may be larger than a protruding height dimension of the joining rib. Since the reinforcing rib is accommodated in the groove of the cooler, the height dimension of the reinforcing rib can be made larger than the height dimension of the joining rib. As the height dimension of the reinforcing rib increases, the rigidity of the protection panel can be increased.

In one embodiment of the present technology, the at least one joining rib may include a first joining rib, a second joining rib, and a third joining rib that are arranged along the first direction. In this case, the at least one reinforcing rib may include a plurality of first reinforcing ribs positioned between the first joining rib and the second joining rib and arranged along the second direction, and a plurality of second reinforcing ribs positioned between the second joining rib and the third joining rib and arranged along the second direction. With this configuration, the rigidity of the protection panel is more effectively increased because the reinforcing ribs are arranged between the two adjacent joining ribs.

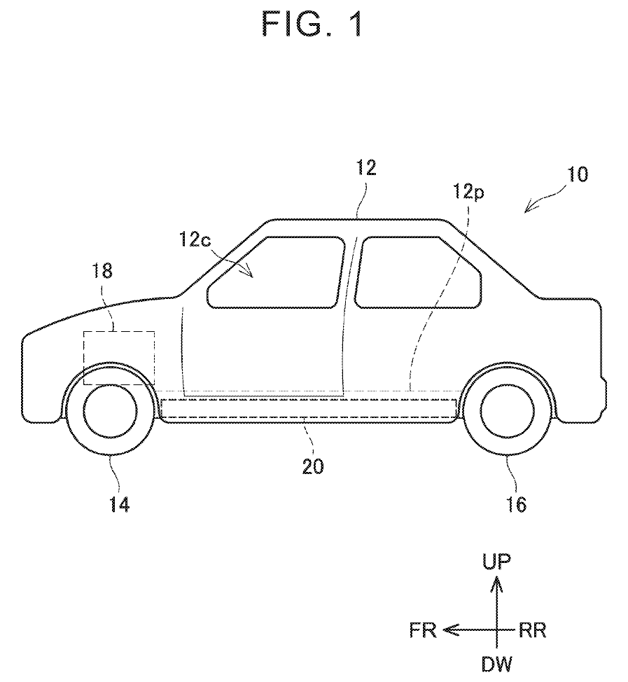

A battery pack 20 according to an embodiment will be described with reference to the drawings. The battery pack 20 according to the present embodiment is mounted on an electrified vehicle 10. Referring to FIG. 1, the electrified vehicle 10 will be described. The electrified vehicle 10 is a battery electric vehicle (BEV). However, the electrified vehicle 10 is not limited to a BEV, and may be another type of electrified vehicle such as a hybrid electric vehicle (HEV) or a plug-in hybrid electric vehicle (PHEV).

The directions of the battery pack 20 in the present specification and the drawings are directions when the battery pack 20 is mounted on the electrified vehicle 10, and correspond to the directions in the electrified vehicle 10. In the drawings, a direction FR indicates forward in a front-rear direction of the electrified vehicle 10, and a negative direction RR relative to the direction FR indicates rearward in the front-rear direction of the electrified vehicle 10. A direction LH indicates leftward in a right-left direction of the electrified vehicle 10, and a negative direction RH relative to the direction LH indicates rightward in the right-left direction of the electrified vehicle 10. A direction UP indicates upward in an up-down direction of the electrified vehicle 10, and a negative direction DW relative to the direction UP indicates downward in the up-down direction of the electrified vehicle 10.

The electrified vehicle 10 includes a vehicle body 12, a plurality of wheels 14, 16, and a motor unit 18 in addition to the battery pack 20. The electrified vehicle 10 is an electrified vehicle. The vehicle body 12 is made of a metal such as a steel-based material or an aluminum-based material. The wheels 14, 16 support the vehicle body 12. The wheels 14, 16 include a pair of front wheels 14 located at the front of the vehicle body 12 and a pair of rear wheels 16 located at the rear of the vehicle body 12. The front wheels 14 are located on the right and left sides of the vehicle body 12. The rear wheels 16 are located on the right and left sides of the vehicle body 12. The vehicle body 12 has a cabin 12c inside. The cabin 12c is configured to accommodate an occupant. The vehicle body 12 includes a floor panel 12p. The floor panel 12p defines the floor of the cabin 12c.

The motor unit 18 includes a travel motor that drives the front wheels 14. However, the motor unit 18 is not limited to driving the front wheels 14, but may drive at least one of the wheels 14, 16. The motor unit 18 may be disposed forward of the cabin 12c.

The battery pack 20 is electrically connected to the motor unit 18 via, for example, a power conversion device (not shown). The battery pack 20 supplies the motor unit 18 with electric power to drive the wheels 14, 16. The battery pack 20 is disposed at the lower part of the vehicle body 12. Specifically, the battery pack 20 is disposed below the floor panel 12p of the vehicle body 12. The battery pack 20 is supported by the vehicle body 12. For example, the battery pack 20 may be fixed to the right and left side sills of the vehicle body 12.

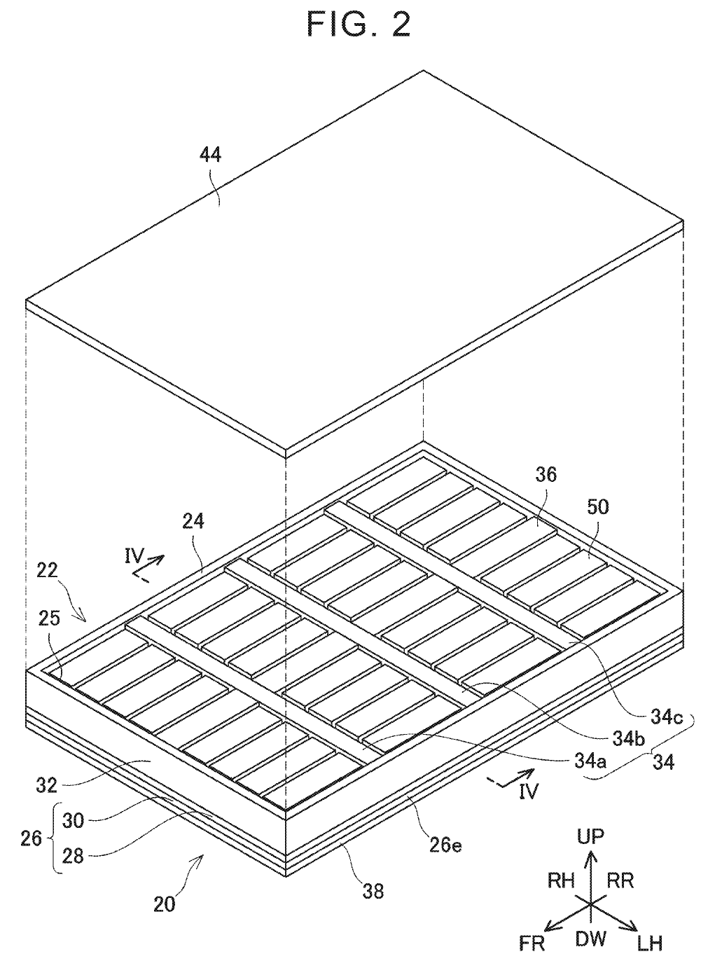

The battery pack 20 will be described in detail with reference to FIGS. 2 to 5. As shown in FIG. 2, the battery pack 20 is a thin battery pack having a small dimension in the up-down direction. The battery pack 20 has a flat rectangular parallelepiped shape. The dimension of the battery pack 20 in the up-down direction is smaller than the dimension of the battery pack 20 in the right-left direction, and the dimension of the battery pack 20 in the right-left direction is smaller than the dimension of the battery pack 20 in the front-rear direction.

The battery pack 20 includes a plurality of battery modules 50, a casing 22, a protection panel 38, and a cover 44. The casing 22 houses the battery modules 50.

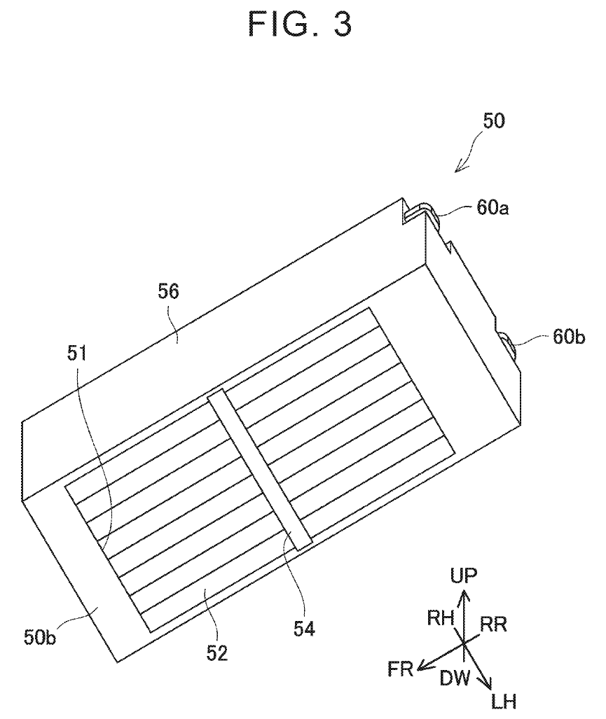

As shown in FIG. 3, the battery module 50 includes a plurality of battery cells 52. In a modification, the battery module 50 may include only one battery cell 52. Each of the battery cells 52 is a secondary battery cell configured to be chargeable and dischargeable. The secondary battery cell is, for example, a lithium ion battery cell. The battery module 50 has an opening 51 in a lower surface 50b. On the lower surface 50b of the battery module 50, the end faces of the battery cells 52 are exposed through the opening 51. Each battery cells 52 is a pouch battery (also referred to as "laminate battery") cell. Each battery cell 52 has a flat shape. The battery cells 52 are stacked along the thickness direction (right-left direction in FIG. 3). The battery cells 52 are bound by a binding band 54 while being compressed in the stacking direction. The battery module 50 includes a cathode terminal 60a and an anode terminal 60b at one end of each battery cell 52 in the longitudinal direction (front-rear direction in FIG. 3). The battery module 50 includes a module casing 56 that houses the battery cells 52. The opening 51 is defined by the module casing 56.

The casing 22 is made of a metal such as aluminum. As shown in FIG. 2, the casing 22 includes a casing body 24 and a plurality of beams 34a, 34b, 34c, 36. The casing body 24 includes a bottom wall 26 located below the battery modules 50, and a peripheral wall 32 standing upright from an outer peripheral edge 26e of the bottom wall 26. The peripheral wall 32 extends around the outer peripheral edge 26e of the bottom wall 26. The casing body 24 has an opening 25 that is open upward. The opening 25 is defined by the inner surface of the peripheral wall 32. The cover 44 is a plate-shaped member and is disposed to close the opening 25 of the casing body 24 from the top. The cover 44 is made of a metal such as aluminum.

The beams 34a, 34b, 34c, 36 are skeletal members of the casing 22. The beams 34a, 34b, 34c, 36 extend along an upper surface 26a of the bottom wall 26. The beams 34a, 34b, 34c, 36 include a plurality of first beams 34a, 34b, 34c and a second beam 36. The first beams 34a, 34b, 34c extend in the right-left direction to cross the upper surface 26a of the bottom wall 26. The first beams 34a, 34b, 34c each extend from the left part of the peripheral wall 32 to the right part of the peripheral wall 32. The second beam 36 extends in the front-rear direction to cross the upper surface 26a of the bottom wall 26. The first beams 34a, 34b, 34c are arranged at intervals in the front-rear direction. The second beam 36 is disposed at the center of the bottom wall 26 in the right-left direction. The first beams 34a, 34b, 34c (hereinafter referred to as "first beams 34") are disposed orthogonally to the second beam 36. As shown in FIG. 2, the first beams 34 extend across the second beam 36. The first beams 34 and the second beam 36 are formed to be fittable together. The beams 34, 36 are fixed to the upper surface 26a of the bottom wall 26.

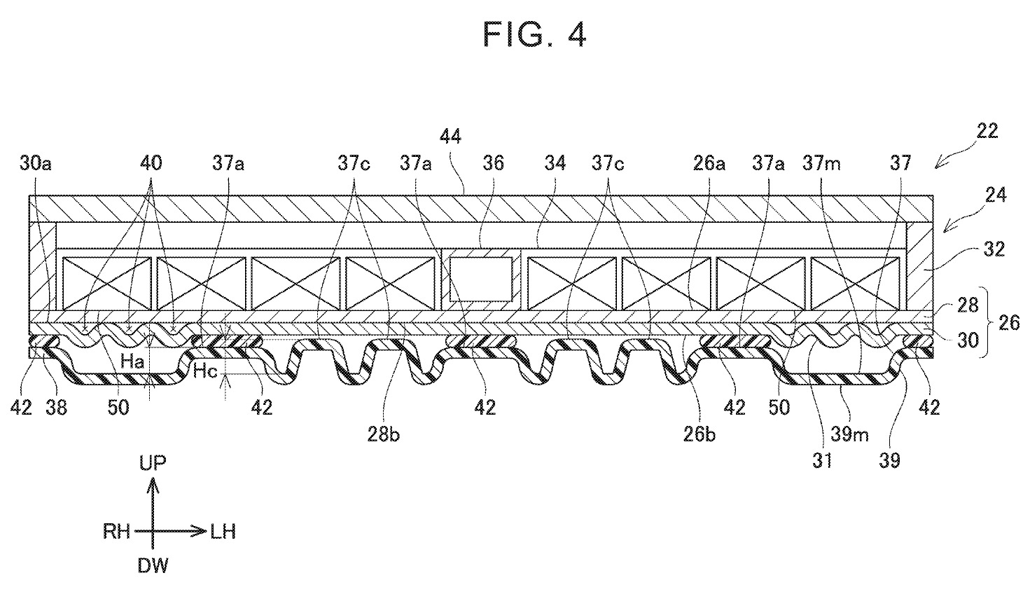

As shown in FIG. 4, the bottom wall 26 includes an upper panel 28 and a lower panel 30 that face each other in the up-down direction. Each of the upper panel 28 and the lower panel 30 is a plate-shaped member. The upper panel 28 and the lower panel 30 are joined together. Channels 40 along which a coolant flows are defined between the upper panel 28 and the lower panel 30. The bottom wall 26 of the casing 22 functions as a cooler for the battery modules 50. The lower surface of the lower panel 30 (i.e., a lower surface 26b of the bottom wall 26) has a plurality of grooves 31 recessed toward the upper panel 28. The grooves 31 extend along the channels 40. Regions of an upper surface 30a of the lower panel 30 that protrude upward due to the grooves 31 are in contact with a lower surface 28b of the upper panel 28. Thus, the channels 40 are formed between the lower surface 28b of the upper panel 28 and the upper surface 30a of the lower panel 30. The flow of the coolant through the channels 40 adjusts the temperature of the battery modules 50 disposed on the upper surface 26a of the bottom wall 26.

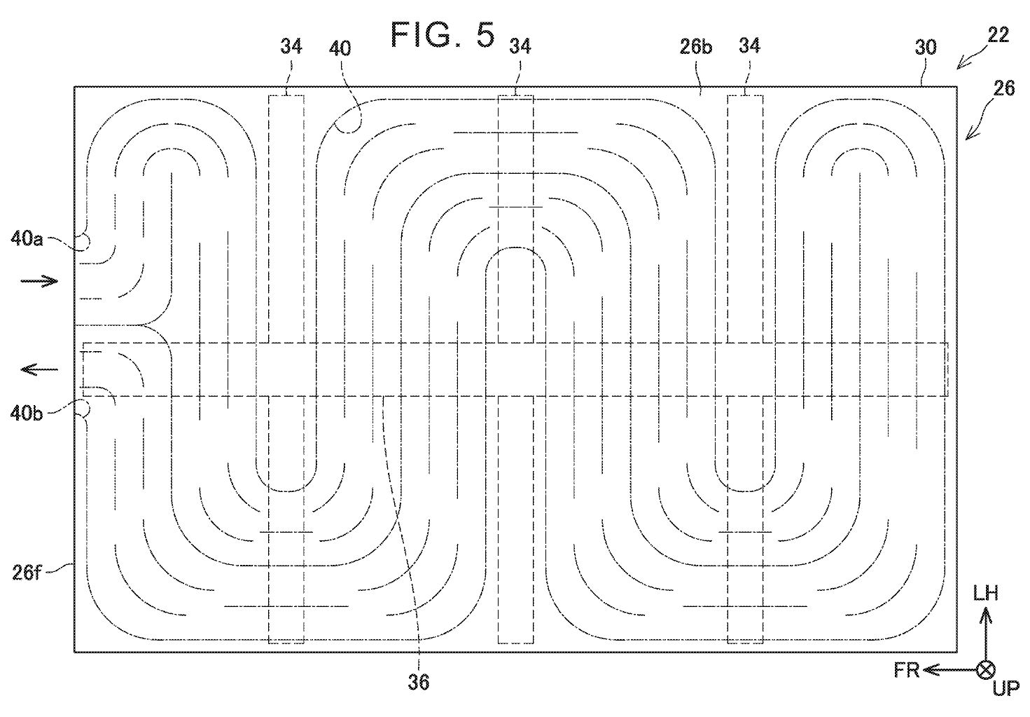

FIG. 5 shows the casing 22 as viewed from the bottom. In FIG. 5, the channels 40 formed inside the bottom wall 26 are shown by chain lines. In FIG. 5, the beams 34, 36 fixed to the upper surface 26a of the bottom wall 26 are shown by dashed lines. As shown in FIG. 5, supply ports 40a through which the coolant is supplied to the channels 40 and discharge ports 40b through which the coolant is discharged from the channels 40 are disposed at a front end 26f of the bottom wall 26. The channel 40 meanders from the supply port 40a to the discharge port 40b.

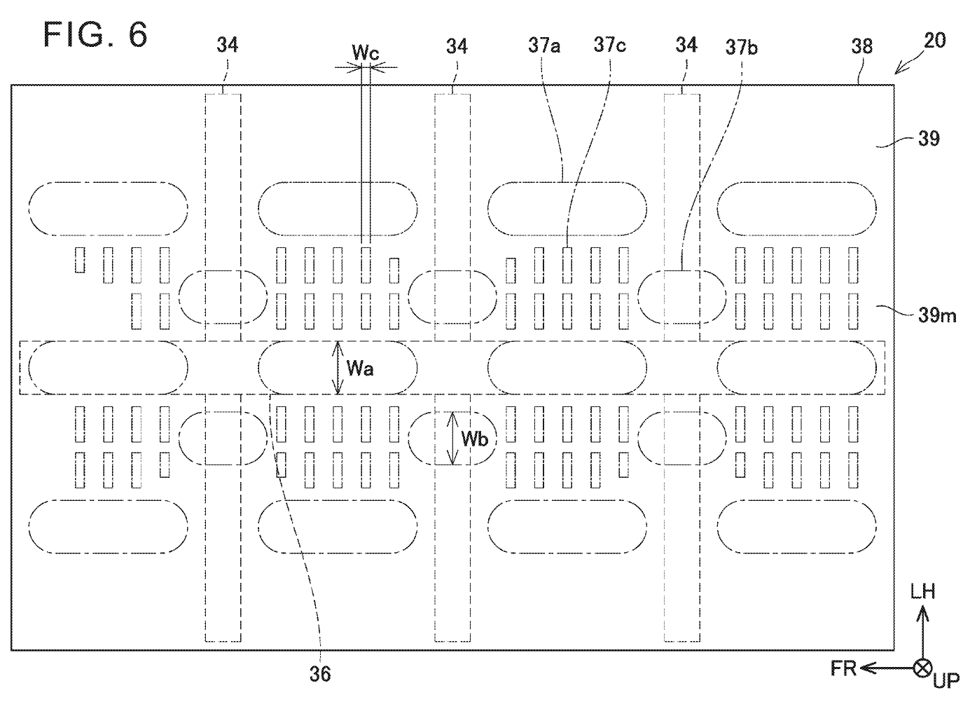

As shown in FIGS. 4 and 6, the protection panel 38 is disposed on the lower surface 26b of the bottom wall 26. The protection panel 38 is a plate-shaped member having a predetermined profile. The protection panel 38 is a protection member that covers the bottom wall 26 from the bottom. The protection panel 38 is located at the lowermost part of the battery pack 20 and is exposed to a road surface. By providing the protection panel 38, influence on the battery modules 50 from the road surface etc. (e.g., influence of collision or rainwater) is reduced. The protection panel 38 is joined to the lower surface 26b of the bottom wall 26 via adhesives 42. The protection panel 38 is made of resin.

An upper surface 37 of the protection panel 38 includes a plurality of joining ribs 37a, 37b and a plurality of reinforcing ribs 37c. The joining ribs 37a, 37b and the reinforcing ribs 37c each protrude toward the bottom wall 26. The joining ribs 37a, 37b are provided to join the bottom wall 26 to the protection panel 38. The reinforcing ribs 37care provided to increase the rigidity of the protection panel 38.

FIG. 6 is a bottom view of the battery pack 20, showing a lower surface 39 of the protection panel 38. The joining ribs 37a, 37b and the reinforcing ribs 37c are shown by chain lines. In FIG. 6, the beams 34, 36 fixed to the upper surface 26a of the bottom wall 26 are shown by dashed lines as in FIG. 5. The protection panel 38 has a constant thickness. That is, a region enclosed by the chain line on the lower surface 39 of the protection panel 38 is recessed toward the far side of the drawing sheet with respect to a main region 39m of the lower surface 39 of the protection panel 38. In a modification, however, the region enclosed by the chain line on the lower surface 39 need not be recessed. In this case, the thickness of the protection panel 38 may be increased in the range in which the joining ribs 37a, 37b and the reinforcing ribs 37c are provided.

The joining ribs 37a, 37b are joined to the bottom wall 26 via the adhesives 42. The joining ribs 37a, 37b extend along the front-rear direction on the upper surface 37 of the protection panel 38. The joining ribs 37a, 37b include a plurality of first joining ribs 37a and a plurality of second joining ribs 37b. The first joining ribs 37a and the second joining ribs 37b are arranged alternately in the front-rear direction. In one example, the dimension of the second joining rib 37b in the front-rear direction is smaller than the dimension of the first joining rib 37a in the front-rear direction.

The specific disposition of the joining ribs 37a, 37b is not particularly limited. For example, the first joining ribs 37a are disposed in four rows and three columns. The first joining ribs 37a are disposed so as not to overlap the first beams 34 of the casing 22. Among the plurality of first joining ribs 37a, the first joining ribs 37a located at the center in the right-left direction are disposed at positions where they overlap the second beam 36 of the casing 22. The second joining ribs 37b are disposed in three rows and two columns. The second joining ribs 37b are positioned between the first joining ribs 37a in the right-left direction and are disposed at positions where they overlap the first beams 34 of the casing 22.

The reinforcing ribs 37c extend on the upper surface 37 of the protection panel 38 along the right-left direction intersecting the front-rear direction in which the joining ribs 37a, 37b extend. The reinforcing ribs 37c are disposed between two adjacent joining ribs 37a, 37b among the plurality of joining ribs 37a, 37b. Each reinforcing rib 37c is accommodated in a corresponding groove 31 in the bottom wall 26. A width dimension Wc of each reinforcing rib 37c is smaller than a width dimension Wa of each first joining rib 37a and a width dimension Wb of each second joining rib 37b. The width dimension refers to a dimension in a plane direction perpendicular to the direction in which the ribs 37a, 37b, 37c extend on the upper surface 37 of the protection panel 38. A protruding height dimension Hc of each reinforcing rib 37c is larger than a protruding height dimension Ha of each first joining rib 37a. The height dimension refers to a dimension of each of the ribs 37a, 37b, 37c that protrudes in the up-down direction from a main region 37m of the upper surface 37 of the protection panel 38. In the protection panel 38, the main region 37m of the upper surface 37 is located opposite to the main region 39m of the lower surface 39. The height dimension Ha of the first joining rib 37a and the height dimension of the second joining rib are substantially equal to each other. However, the height dimension Ha of the first joining rib 37a and the height dimension of the second joining rib may be different from each other. In this case, the protruding height dimension Hc of each reinforcing rib 37c may be larger than both the height dimension Ha of the first joining rib 37a and the height dimension of the second joining rib. A portion of each reinforcing rib 37c that is higher than each of the joining ribs 37a, 37b is accommodated in the corresponding groove 31. In a modification, the protection panel 38 need not have the joining ribs 37a, 37b. In this case, the reinforcing rib 37c may be substantially entirely accommodated in the groove 31.

As described above, the battery pack 20 of the present embodiment is disposed below the floor panel 12p of the electrified vehicle 10. In this case, the protection panel 38 is exposed below the electrified vehicle 10. To increase the rigidity of the protection panel 38, it is conceivable to provide reinforcing ribs to the protection panel 38. When the reinforcing ribs are provided to the protection panel 38, however, the substantial thickness of the protection panel 38 increases. As a result, the dimension of the battery pack 20 in the up-down direction may increase as well.

In the present embodiment, the reinforcing ribs 37c provided to the protection panel 38 are accommodated in the grooves 31 extending along the channels 40 in the bottom wall 26. Therefore, even when the substantial thickness of the protection panel 38 increases by providing the reinforcing ribs 37c to the protection panel 38, the increase in dimension of the battery pack 20 in the up-down direction can be suppressed. The bottom wall 26 is an example of a "cooler" according to the present technology, and the channel 40 is an example of a "cooling channel" according to the present technology.

In the present embodiment, the reinforcing ribs 37c extend in the right-left direction on the upper surface 37 of the protection panel 38, and the joining ribs 37a, 37b extend in the front-rear direction on the upper surface 37 of the protection panel 38. With this configuration, the rigidity of the protection panel 38 is effectively increased by the combination of the reinforcing ribs 37c and the joining ribs 37a, 37b extending in different directions. The joining ribs 37a, 37b are examples of a "joining rib" according to the present technology. The right-left direction is an example of a "first direction" according to the present technology, and the front-rear direction is an example of a "second direction" according to the present technology.

in the present embodiment, the width dimension Wc of each reinforcing rib 37c is smaller than the width dimensions Wa, Wb of the joining ribs 37a, 37b. By setting the relatively large width dimensions Wa, Wb of the joining ribs 37a, 37b, the protection panel 38 can be firmly bonded to the bottom wall 26. By setting the relatively small width dimension Wc of each reinforcing rib 37c, each reinforcing rib 37c can be easily accommodated in the groove 31 in the bottom wall 26.

In the present embodiment, the height dimension Hc of each reinforcing rib 37c is larger than the height dimension Ha of each of the joining ribs 37a, 37b. In this case, each reinforcing rib 37c is accommodated in a corresponding groove 31 in the bottom wall 26. Therefore, the height dimension Hc of each reinforcing rib 37c can be made larger than the height dimension Ha of each of the joining ribs 37a, 37b. As the height dimension Hc of each reinforcing rib 37c increases, the rigidity of the protection panel 38 can be increased.

In the present embodiment, the reinforcing ribs 37c are disposed between two adjacent first joining ribs 37a among the plurality of first joining ribs 37a arranged in the right-left direction. Specifically, the reinforcing ribs 37c are disposed between the first joining rib 37a at the left end and the first joining rib 37a located at the middle between the right and left ends among the three first joining ribs 37a arranged in a row along the right-left direction. Further, the reinforcing ribs 37c are disposed between the first joining rib 37a at the right end and the first joining rib 37a located at the middle between the first joining ribs 37a at the right and left ends among the three first joining ribs 37a arranged in a row along the right-left direction. With this configuration, the rigidity of the protection panel is more effectively increased because the reinforcing ribs are arranged between the two adjacent joining ribs. The first joining ribs 37a at the left end, at the middle, and at the right end that are arranged in a row along the right-left direction are examples of a "first joining rib," a "second joining rib," and a "third joining rib" according to the present technology. The reinforcing ribs 37c located between the first joining rib 37a at the left end and the first joining rib 37a at the middle are examples of a "first reinforcing rib," and the reinforcing ribs 37c located between the first joining rib 37a at the middle and the first joining rib 37a at the right end are examples of a "second reinforcing rib." However, the number of the reinforcing ribs 37c is not limited to plural, and may be one.

In the present embodiment, the relationship between the first joining ribs 37a and the reinforcing ribs 37c can also be applied to the second joining ribs 37b and the reinforcing ribs 37c. That is, the reinforcing ribs 37c are disposed between two adjacent second joining ribs 37b among the plurality of second joining ribs 37b arranged in the front-rear direction. Specifically, the reinforcing ribs 37c are disposed between the second joining rib 37b at the front end and the second joining rib 37b located at the middle between the second joining ribs 37b at the front and rear ends among the three second joining ribs 37b arranged in a row along the front-rear direction. Further, the reinforcing ribs 37c are disposed between the second joining rib 37b at the rear end and the second joining rib 37b located at the middle between the second joining ribs 37b at the front and rear ends among the three second joining ribs 37b arranged in a row along the front-rear direction. The second joining ribs 37b at the front end, at the middle, and at the rear end that are arranged in a row along the front-rear direction are examples of the "first joining rib," the "second joining rib," and the "third joining rib" according to the present technology. The reinforcing ribs 37c located between the second joining rib 37b at the front end and the second joining rib 37b at the middle are examples of the "first reinforcing rib," and the reinforcing ribs 37c located between the second joining rib 37b at the middle and the second joining rib 37b at the rear end are examples of the "second reinforcing rib."

In a modification, the protection panel 38 need not have both the first joining ribs 37a and the second joining ribs 37b. For example, the protection panel 38 may have either the first joining ribs 37a or the second joining ribs 37b. In another modification, the number of the joining ribs 37a, 37b is not limited to plural, and may be one.

What is claimed is:

1. A battery pack comprising:
a battery cell;
a cooler located below the battery cell and having a cooling channel; and
a protection panel that covers the cooler from a bottom, wherein:
a groove extending along the cooling channel is provided to a lower surface of the cooler;
at least one reinforcing rib protruding toward the cooler is provided to an upper surface of the protection panel; and
the reinforcing rib is accommodated in the groove of the cooler.

2. The battery pack according to claim 1, wherein:
at least one joining rib protruding toward the cooler is provided to the protection panel;
the protection panel is joined to the cooler at the joining rib via an adhesive;
the reinforcing rib extends in a first direction on the upper surface of the protection panel; and
the joining rib extends in a second direction intersecting the first direction on the upper surface of the protection panel.

3. The battery pack according to claim 2, wherein, on the upper surface of the protection panel, a width dimension of the reinforcing rib that is perpendicular to the first direction is smaller than a width dimension of the joining rib that is perpendicular to the second direction.

4. The battery pack according to claim 2, wherein, on the upper surface of the protection panel, a protruding height dimension of the reinforcing rib is larger than a protruding height dimension of the joining rib.

5. The battery pack according to claim 2, wherein:
the at least one joining rib includes a first joining rib, a second joining rib, and a third joining rib that are arranged along the first direction; and
the at least one reinforcing rib includes
a plurality of first reinforcing ribs positioned between the first joining rib and the second joining rib and arranged along the second direction, and
a plurality of second reinforcing ribs positioned between the second joining rib and the third joining rib and arranged along the second direction.
